(19) United States
(12) Patent Application Publication
(10) Pub. No.: US 2025/0067271 A1
(43) Pub. Date: Feb. 27, 2025

(54) VENTILATION SYSTEM

(71) Applicant: DELTA ELECTRONICS, INC., Taoyuan City (TW)

(72) Inventors: YU-HSIANG HUANG, Taoyuan City (TW); YUAN-CHUAN LIU, Taoyuan City (TW); CHIH-HUA LIN, Taoyuan City (TW)

(21) Appl. No.: 18/945,339

(22) Filed: Nov. 12, 2024

Related U.S. Application Data
(63) Continuation of application No. 16/773,030, filed on Jan. 27, 2020.
Application No. 16/773,030 is a continuation-in-part of application No. 15/797,367, filed on Oct. 30, 2017, now abandoned.
Application No. 15/797,367 is a continuation-in-part of application No. 14/616,126, filed on Feb. 6, 2015, now abandoned.

(30) Foreign Application Priority Data
Oct. 15, 2014 (TW) 103135619

(51) Int. Cl. F04D 29/00; F04D 29/42; F04D 29/60; F21S 8/02; F21V 33/00; F21Y 115/10; F24F 7/007

(52) U.S. Cl. CPC F04D 29/005; F04D 29/4213; F04D 29/4226; F04D 29/602; F21S 8/026; F21V 33/0096; F24F 7/007; F21Y 2115/10; F24F 2221/02

(57) ABSTRACT

A ventilation system comprises a ventilation fan with a lamp for installing to a ceiling having an installation opening. The ventilation fan comprises a housing, a fan module, a power box, a junction box, a lamp module and a support. The housing has a first opening and an air outlet. The fan module comprises an inlet opening and an outlet opening. The outlet opening communicates with the air outlet. The power box has a first circuit board. The lamp module and the housing are located at opposite sides of the installation opening. The junction box is electrically connected to the first circuit board and the lamp module. The impeller comprises a hub, and a ratio of a height of the hub to a height of the housing is less than 0.5. A ratio of a height of the impeller to a height of the housing is greater than 0.65.

### CROSS REFERENCE TO RELATED APPLICATIONS

This application is a Continuation Application (CA) of an earlier filed, pending application, having application Ser. No. 16/773,030 and filed on Jan. 27, 2020, which is a Continuation-In-Part (CIP) of an earlier filed, pending application, having application Ser. No. 15/797,367 and filed on Oct. 30, 2017, which is a Continuation-In-Part (CIP) of an earlier filed, pending, application, having application Ser. No. 14/616,126 and filed on Feb. 6, 2015; the entire contents of all of which are hereby incorporated by reference.

### BACKGROUND OF THE INVENTION

### Field of Invention

The invention relates to a ventilation system and, in particular, to a ventilation system comprises a ventilation fan with a lamp for installing to a ceiling.

### Related Art

For the sake of blocking the outdoor noise and heat and remaining the indoor temperature, the buildings are usually constructed by special materials to create unventilated rooms. Accordingly, a proper ventilation mechanism is required to exhaust the harmful contaminations.

In order to improve the air convection in the rooms, many buildings are equipped with ventilation fans for supplying the fresh air. However, the conventional ventilation fan only has the ventilation function, and the applicability thereof is thus limited.

Moreover, the performance of the conventional ventilation fan also needs to be improved, especially the performance of a small size ventilation fan.

### SUMMARY OF THE INVENTION

A ventilation system comprising a ventilation fan with a lamp for installing to a ceiling. The ceiling has an installation opening. The ventilation fan with the lamp according to this invention is used to be installed to the installation opening of the ceiling. The ventilation fan comprises a housing, a fan module, a power box, a junction box and a lamp module. The housing comprises a top plate and a side wall. The top plate and the side wall are connected with each other to form a first opening. The first opening is aligned with the installation opening. An air outlet is formed at the side wall. The fan module is disposed in the housing. The fan module has an inlet opening and an outlet opening. The inlet opening is aligned with the first opening. The outlet opening communicates with the air outlet of the housing. Three accommodation spaces are formed between the housing and the fan module at different corners of the housing and disposed away from the air outlet of the housing, respectively. The power box is disposed in the housing and located at one of the accommodation space. The power box comprises a first circuit board. The first circuit board is disposed in the power box. The junction box is disposed in the housing and located at one of the accommodation space. The power box and the junction box are located at different accommodation spaces. The lamp module is disposed out of the installation opening and covering the installation opening. The lamp module and the housing are located at opposite sides of the installation opening of the ceiling. A gap is formed between the lamp module and the ceiling. The gap serves as an air inlet of the ventilation fan. A support is disposed between the ceiling and the lamp module. The junction box is electrically connected to the first circuit board of the power box and the lamp module.

In one embodiment, the fan module further comprises a frame, an impeller, a motor and a second circuit board. The frame comprises a pillow disposed at the bottom of the frame. The frame and the pillow are connected with each other to form the inlet opening and the outlet opening. The impeller is disposed in the frame. The motor is connected to and drives the impeller to rotate. The second circuit board is disposed in the frame and electrically connected to the motor and the first circuit board of the power box.

In one embodiment, the motor is an external-rotor DC motor.

In one embodiment, the frame further comprises a shaft tube disposed at the pillow. The second circuit board is disposed around the outer periphery of the shaft tube.

In one embodiment, the second circuit board is a circular board and comprising a water-proof structure.

In one embodiment, the housing further comprises at least one installation hole. The junction box is disposed in the housing by installing to the at least one installation hole.

In one embodiment, the frame further comprises a mounting portion, the power box is connected to the mounting portion and then disposed in the housing with the fan module.

In one embodiment, the housing further comprises at least one extension portion. The at least one extension portion is disposed on the side wall inside the housing. A slot is formed on the at least one extension portion. The lamp module comprises at least one elastic element. The at least one elastic element penetrating through the slot for preventing the lamp module from falling down directly during disassembling.

In one embodiment, the frame further comprises at least one extension portion. The at least one extension portion is disposed on the frame. A slot is formed on the at least one extension portion. The lamp module comprises at least one elastic element. The at least one elastic element penetrating through the slot for preventing the lamp module from falling down directly during disassembling.

In one embodiment, a height of the housing is equal to or less than 4 inch.

In one embodiment, the impeller comprises a hub. A ratio of a height of the hub to a height of the housing is less than 0.5.

In one embodiment, a ratio of a diameter of the impeller to a value of ¼ of perimeter of the first opening is greater than 0.7.

In one embodiment, a ratio of an area of the inlet opening to an area of the first opening is greater than 0.25.

In one embodiment, a ratio of a height of the impeller to a height of the housing is greater than 0.65.

In one embodiment, the first circuit board of the power box outputs DC power to the fan module.

In one embodiment, the support contacts the ceiling.

In one embodiment, the lamp module and the support are connected by a contact portion, and the gap is configured between the lamp module and the support.

In one embodiment, the lamp module comprises a light source, a base, at least one optical component, and a lamp cover. The optical component is disposed on the base. The lamp cover is disposed at one side of the optical component away from the base. The light output direction of the light source of the lamp module is not equal to the light output direction of the lamp module.

In one embodiment, the optical component is a light diffuser. The light diffuser receives the light emitted from the light source of the lamp module.

In one embodiment, the light source is disposed at the side of the light diffuser.

As mentioned above, the ventilation fan with the lamp of this disclosure is installed to the ceiling having an installation opening. The ventilation fan includes a housing, a fan module, a power box, a junction box and a lamp module. The housing has a top plate and a side wall. The top plate and the side wall are connected with each other and form a first opening. An air outlet is formed at the side wall of the housing. The first opening is aligned with the installation opening. The fan module is accommodated in the housing. The fan module has an outlet opening which communicates with the air outlet of the housing. Three accommodation spaces are formed between the housing and the fan module at different corners of the housing and disposed away from the air outlet of the housing, respectively. The power box and the junction box are disposed in the housing and located at two of the accommodation spaces. The power box comprises a first circuit board. The junction box is electrically connected to the first circuit board of the power box and the lamp module. The lamp module is disposed out of the installation opening and covering the installation opening. The lamp module and the housing are located at opposite sides of the ceiling. The lamp module can further block the noise generated by the fan module in operation. Besides, the internal structure of the ventilation fan cannot be viewed by the user directly, so that the appearance of the ventilation fan becomes more elegant. Since the lamp module is integrated in the ventilation fan, it can be fit to various environments so the flexibility and freedom degree for installing the ventilation fan are enhanced. Moreover, this disclosure can reduce the required installation space of the ceiling so as to increase the utility rate of the space. Since the lamp module and the first opening are disposed at opposite sides of the ceiling, the ventilation fan can have large inlet quantity and good air-exchange efficiency. Further, the performance of the ventilation fan can be improved by disposing the power box and the junction box.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a schematic diagram of a ventilation fan with a lamp of the first embodiment of the invention;

FIG. 1B is an exploded view of the ventilation fan of FIG. 1A, which has a support;

FIG. 1C is an exploded view of the ventilation fan of FIG. 1A with a variation;

FIG. 1D is a sectional diagram of the ventilation fan of FIG. 1A;

FIG. 1E is a schematic diagram of the ventilation fan of FIG. 1A without the ceiling and the lamp module;

FIG. 1F is an exploded view of the ventilation fan of FIG. 1E;

FIG. 1G is a schematic diagram of the electrically connection of the power box and the junction box of the ventilation fan of FIG. 1E;

FIG. 1H is a top view of the ventilation fan of FIG. 1E;

FIG. 1I is a sectional diagram of A-A line of the ventilation fan of FIG. 1H;

FIG. 1J is a schematic diagram of the electrically connection of the junction box of the ventilation fan of FIG. 1E and the lamp module;

FIG. 1K is a schematic diagram of the area of the first opening and the area of the inlet opening of the ventilation fan of FIG. 1E;

FIG. 2A is a schematic diagram of a ventilation fan with a lamp of the second embodiment of the invention;

FIG. 2B is an exploded view of the ventilation fan of FIG. 2A; and

FIG. 2C is a sectional diagram of the ventilation fan of FIG. 2A.

### DETAILED DESCRIPTION OF THE INVENTION

The present invention will be apparent from the following detailed description, which proceeds with reference to the accompanying drawings, wherein the same references relate to the same elements.

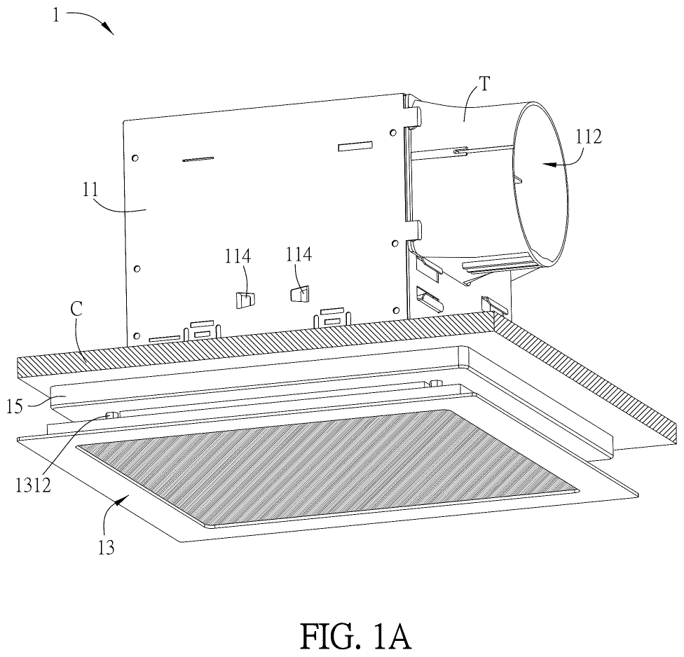

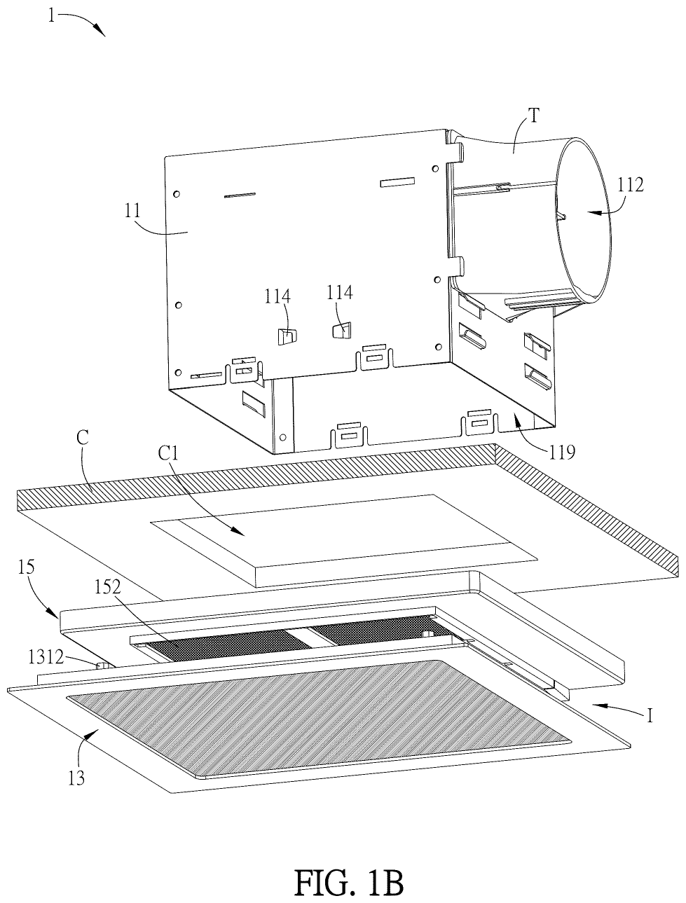

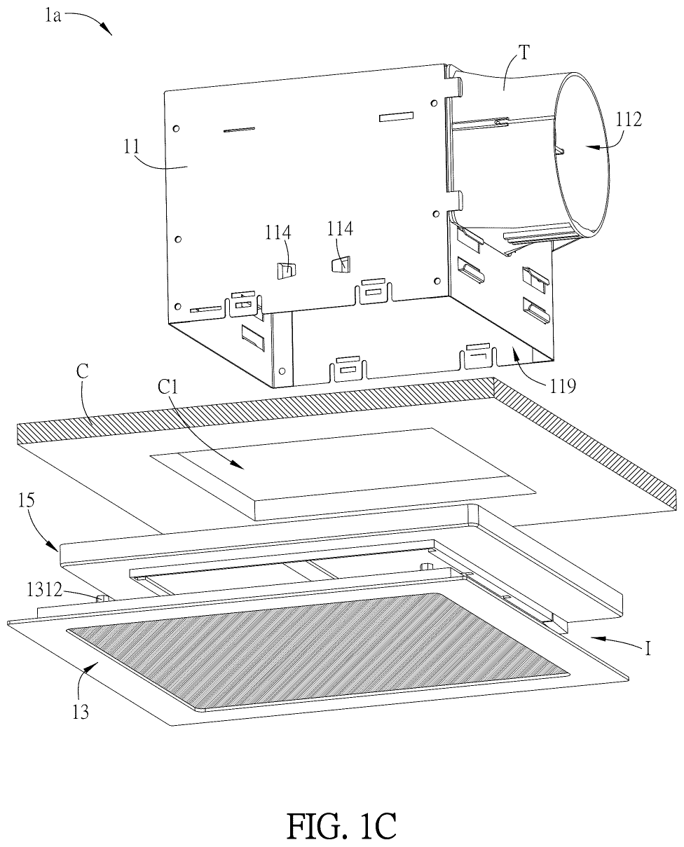

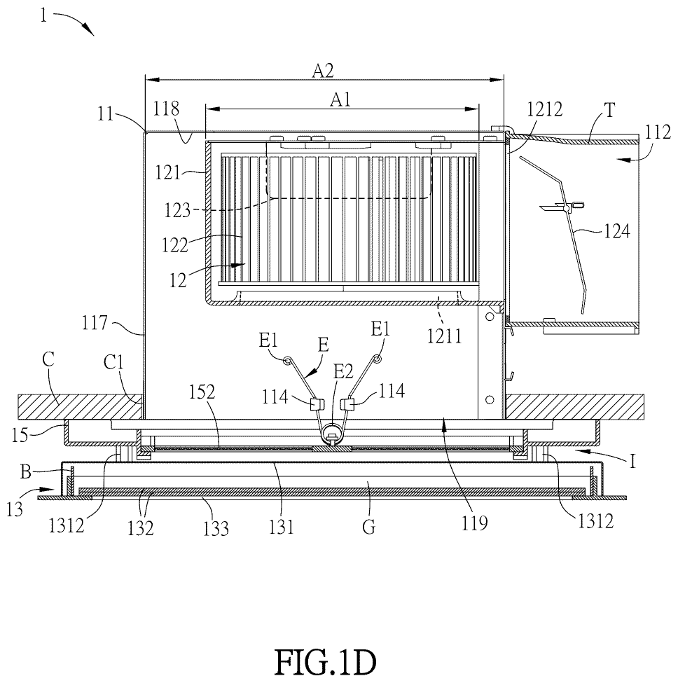

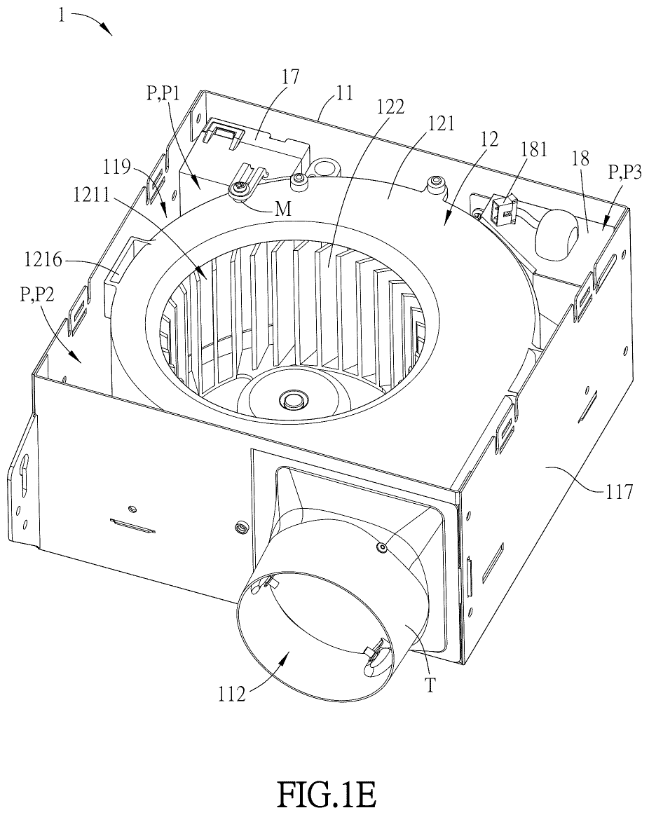

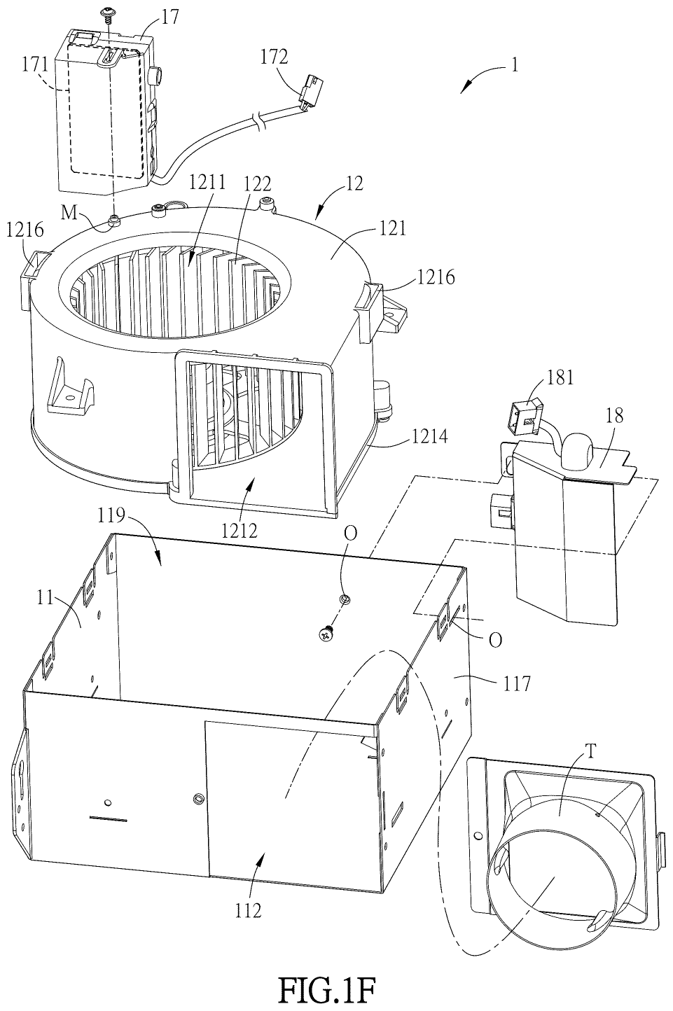

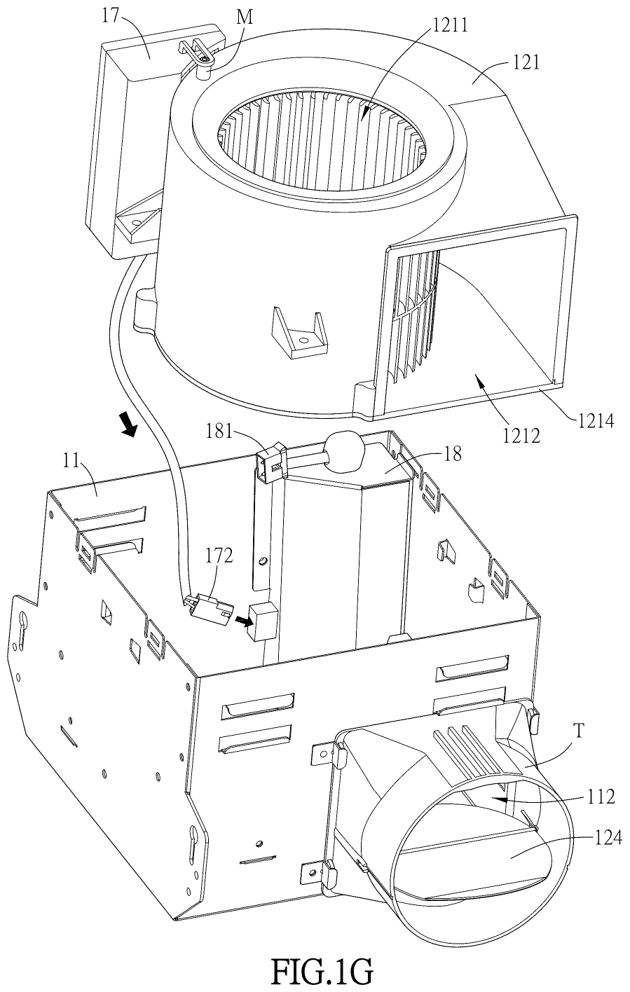

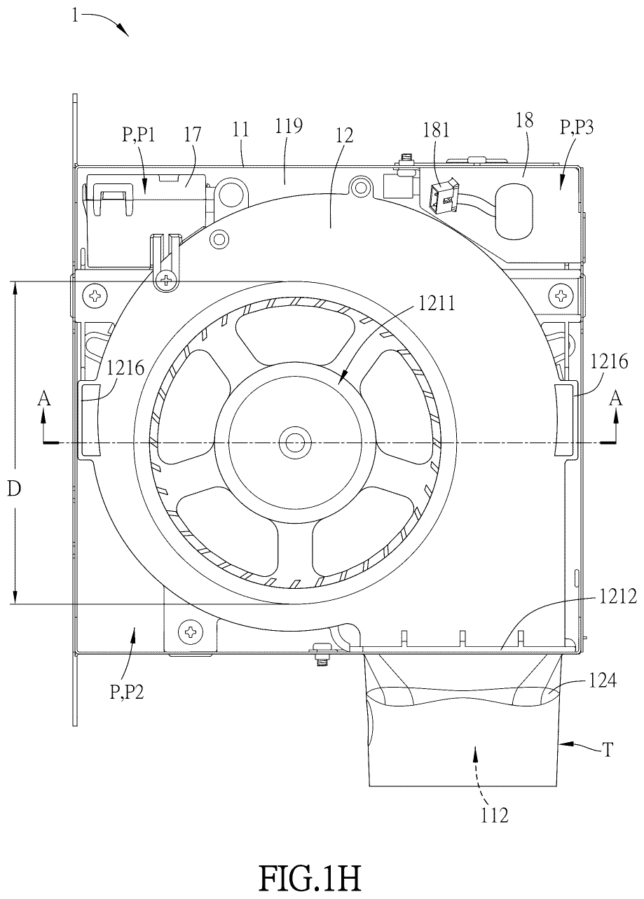

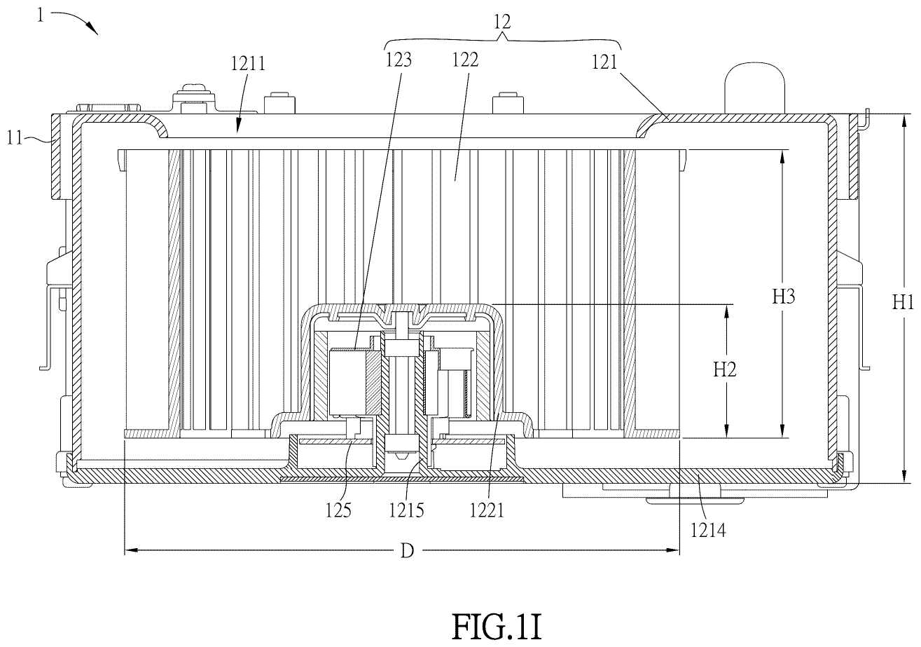

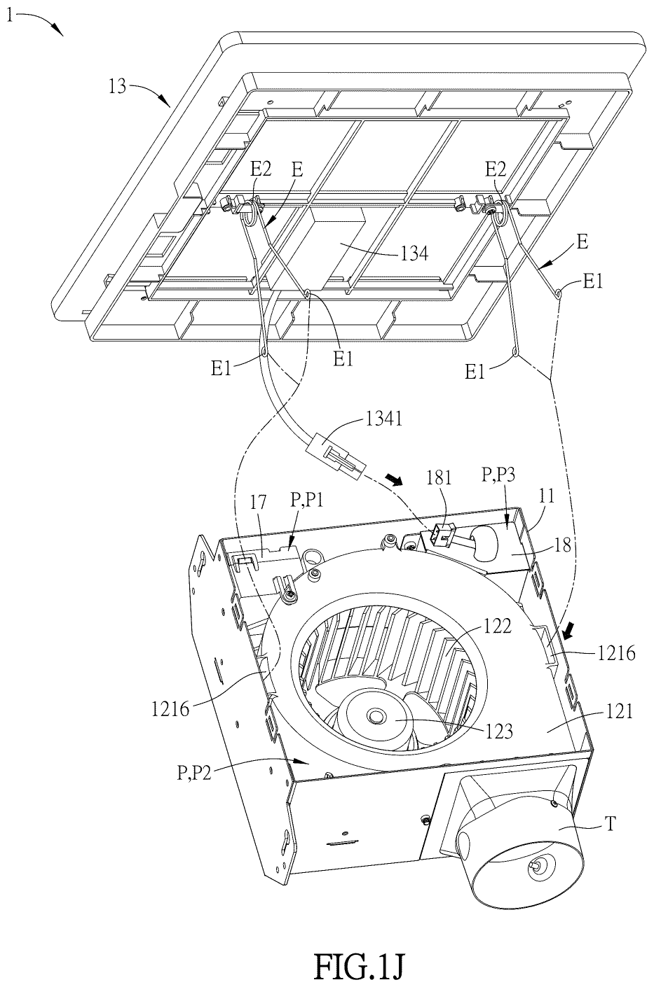

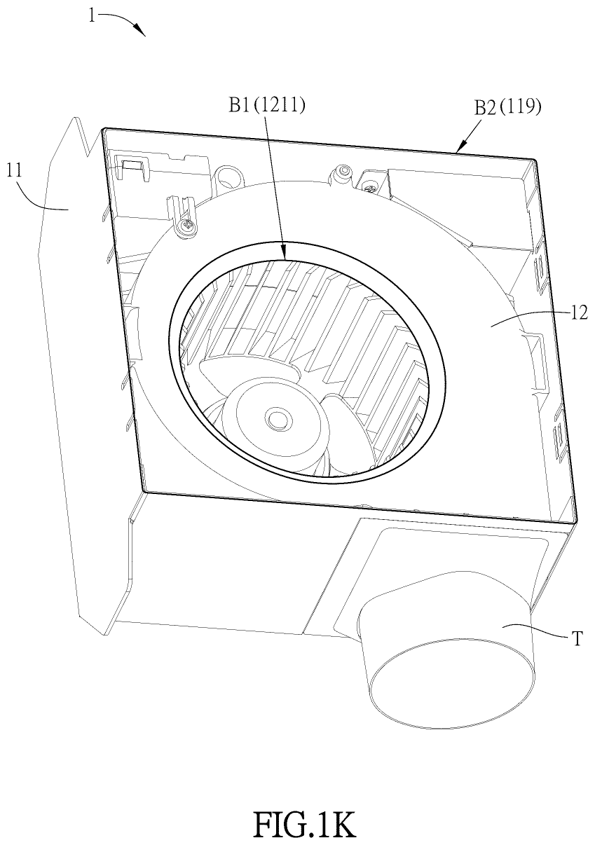

FIG. 1A is a schematic diagram of a ventilation fan with a lamp of the first embodiment of the invention; FIG. 1B is an exploded view of the ventilation fan of FIG. 1A, FIG. 1C is an exploded view of the ventilation fan of FIG. 1A with a variation, FIG. 1D is a sectional diagram of the ventilation fan of FIG. 1A, FIG. 1E is a schematic diagram of the ventilation fan of FIG. 1A without the ceiling and the lamp module, FIG. 1F is an exploded view of the ventilation fan of FIG. 1E, FIG. 1G is a schematic diagram of the electrically connection of the power box and the junction box of the ventilation fan of FIG. 1E, FIG. 1H is a top view of the ventilation fan of FIG. 1E, FIG. 1I is a sectional diagram of A-A line of the ventilation fan of FIG. 1H, FIG. 1J is a schematic diagram of the electrically connection of the junction box of the ventilation fan of FIG. 1E and the lamp module, and FIG. 1K is a schematic diagram of the area of the first opening and the area of the inlet opening of the ventilation fan of FIG. 1E.

As shown in FIGS. 1A to 1E, a ventilation system comprises a ventilation fan with a lamp 1/1a for installing to a ceiling C. The ventilation fan with the lamp 1/1a (abbreviated to the ventilation fan 1/1a hereinafter) is installed to the ceiling C, and the ceiling C has an installation opening C1. To be noted, only a part of the ceiling C and some elements in the ventilation fan 1/1a are shown in FIGS. 1A to 1D for making the drawings more clear. In this embodiment, the ventilation fan 1 includes a housing 11, a fan module 12, a power box 17, a junction box 18 and a lamp module 13. In addition, the ventilation fan 1 may further includes a support 15 for installing with the installation holes (not shown) of the housing 11. The housing 11 can be connected to and fixed to the ceiling C by, for example but not limited to, screws. To be noted, FIG. 1E shows the bottom view of the housing 11 of the ventilation fan 1 without showing the ceiling C and lamp module 13 for making the drawings more clear.

In this embodiment, the housing 11 is roughly a rectangular box and has a top plate 118 and a side wall 117. The side wall 117 includes four perpendicular plates. The top plate 118 and the side wall 117 are connected with each other so as to form a first opening 119. The top plate 118 and the side wall 117 can be integrally formed as one piece or formed by assembling multiple components. Besides, the top plate 118 and the side wall 117 can be fabricated by dustproof, waterproof or fireproof material (e.g. plastics, metal or alloy). In addition, the housing 11 may further include at least one extension portion 114 disposed on the side wall 117 to form a slot. In this embodiment, the extension portion 114 can be formed by punching or pressing the housing 11, and the elastic element E of the lamp module 13 can be connected to the housing 11 through the extension portion 114 so that the lamp module 13 can be fixed.

In more detailed, the side wall 117 includes four plates perpendicular to the top plate 118. In addition, the first opening 119 can be formed by removing the bottom of a rectangular box, i.e. the housing 11. In other words, the housing 11 can be a rectangular box without the bottom.

In addition, the housing 11 may further includes an air outlet 112, which is configured to discharge air or connect the external air channel. The air outlet 112 is formed at the side wall 117 of the housing 11. In this embodiment, the first opening 119 and the air outlet 112 are located at different planes of the housing 11. The housing 11 of the ventilation fan 1 can be installed to the installation opening C1 of the ceiling C. The first opening 119 can be aligned with the installation opening C1 of the ceiling C so that the installation opening C1 can be communicated with the first opening 119. In other embodiments, the air outlet 112 may further be surrounded by a duct T, and the duct T can be connected to the side wall 117 of the housing 11 from outside of the housing 11, as shown in FIG. 1D, or be connected to the side wall 117 from inside of the housing 11, as shown in FIG. 1F.

As shown in FIGS. 1D, 1E, 1F and 1I, the fan module 12 is accommodated in the housing 11. In this embodiment, the fan module 12 includes a frame 121, an impeller 122, and a motor 123. The impeller 122 is disposed in the frame 121. The motor 123 is connected to and drives the impeller 122. Preferably, the motor 123 can be an external-rotor DC motor, which has lower power consumption. The frame 121 has an inlet opening 1211 and an outlet opening 1212. The inlet opening 1211 is aligned with the first opening 119 of the housing 11, and the outlet opening 1212 communicates with the air outlet 112. The impeller 122 and the motor 123 can be fixed inside the frame 121. In more detailed, the frame 121 comprises a pillow 1214 which is disposed at the bottom of the frame 121, wherein the frame 121 and the pillow 1214 are connected with each other to form the inlet opening 1211 and the outlet opening 1212.

As shown in FIGS. 1E and 1H, the fan module 12 is accommodated in the housing 11 and formed three accommodation spaces P between the housing 11 and the fan module 12 at different corners of the housing 11, as P1, P2 and P3 indicated in the figures. In this embodiment, the housing 11 is a rectangular box without the bottom. Three accommodation spaces P (P1, P2 and P3) are formed between the housing 11 and the fan module 12 at different corners of the housing 11 and disposed away from the air outlet 112 of the housing 11, respectively. In more detailed, please refer to FIG. 1H, the air outlet 112 is at a corner of the housing 11 which is a rectangular box. Three accommodation spaces P (P1, P2 and P3) are formed between the housing 11 and the fan module 12 after the fan module 12 disposed in the housing 11. One of the accommodation spaces P/P1 is disposed in the housing 11 and located at the diagonal site which is against the air outlet 112. The other one of the accommodation spaces P/P2 is disposed in the housing 11 and located at the same plane but different side of the housing 11 corresponding to the air outlet 112. Another one of the accommodation spaces P/P3 is disposed in the housing 11 and located at an opposite side against the air outlet 112.

As shown in FIGS. 1E and 1F, the power box 17 is disposed in the housing 11 and located at one of the accommodation space P1 and comprises a first circuit board 171. The first circuit board 171 is disposed in the power box 17. Although the power box 17 is located at the accommodation space P1 in FIGS. 1E and 1F, the power box 17 can be located at, for example but not limited to, the accommodation spaces P2 or P3. The first circuit board 171 is used for AC-DC conversion and high voltage-low voltage conversion.

As shown in FIGS. 1E and 1F, the junction box 18 is disposed in the housing 11 and located at the accommodation space P3. Although the junction box 18 is located at the accommodation space P3 in FIGS. 1E and 1F, the junction box 18 can be located at, for example but not limited to, the accommodation space P1 or P2. To be noted, the power box 17 and the junction box 18 are located at different accommodation spaces. For example, the power box 17 can be located at the accommodation space P1 and the junction box 18 can be located at the accommodation space P2.

As shown in FIGS. 1F, 1G and 1J, the junction box 18 is electrically connected to the first circuit board 171 of the power box 17 and the lamp module 13. The electrically connection between the junction box 18 and the first circuit board 171 of the power box 17 may connect by, but not limit to a wire, a plug or the combination thereof. For example, a plug 172 extended from the first circuit board 171 of the power box 17 is electrically connected to the junction box 18. The first circuit board 171 receives high voltage AC power and output low voltage DC power. The electrically connection between the junction box 18 and the lamp module 13 may connect by, but not limit to a wire, a plug or the combination thereof. For example, a plug 181 extended from the junction box 18 is electrically connected to a light driver 134 by a plug 1341, as shown in FIG. 1J.

As shown in FIGS. 1H and 1I, the fan module 12 further comprises a second circuit board 125 disposed in the frame 121 and electrically connected to the motor 123 and the first circuit board 171 of the power box 17. In more detailed, the pillow 1214 further comprises a shaft tube 1215 extending from the pillow 1214, and the second circuit board 125 is disposed around the outer periphery of the shaft tube 1215. The second circuit board 125 receives low voltage DC power from the first circuit board 171 of the power box 17 to drive the motor 123. For example, the second circuit board 125 is a circular board for disposing round the outer periphery of the shaft tube 1215. The second circuit board 125 may further comprises a water-proof structure. The water-proof structure can protect the second circuit board 125 from the steam in the air to avoid damaging the second circuit board 125.

As shown in FIGS. 1E and 1F, the housing 11 may further comprises at least one installation hole O at the side wall 117, the junction box 18 is disposed in the housing 11 and fixed by screwing with the installation hole O.

As shown in FIGS. 1E, 1F and 1G, the frame 121 may further comprises a mounting portion M, the power box 17 is connected to the mounting portion M and then disposed in the housing 11 with the fan module 12. The power box 17 can be fixed with the mounting portion M of the fan module 12 by screwing or locking.

The detailed design of the size of the housing and the fan module will be described hereinafter.

As shown in FIG. 1I, in this embodiment, the height H1 of the housing 11 is equal to or less than 4 inch. For example, the height H1 of the housing 11 is 100 mm. The design of the height H1 of the housing 11 can reduce the required installation space of the ventilation fan 1 in the ceiling C so as to increase the utility rate of the space.

In another embodiment, the impeller 122 comprises a hub 1221, a ratio of the height H2 of the hub 1211 to the height H1 of the housing 11 is less than 0.5. For example, the height H1 of the housing 11 is 100 mm and the height H2 of the hub 1211 is 31.4 mm. Therefore, the ratio of the height H2 of the hub 1211 to the height H1 of the housing 11 is 0.314 and less than 0.5.

In another embodiment, a ratio of the height H3 of the impeller 122 to the height H1 of the housing 11 is greater than 0.65. For example, the height of the housing 11 is 100 mm and the height H3 of the impeller 122 is 67.5 mm. Therefore, the ratio of the height H3 of the impeller 122 to the height H1 of the housing 11 is 0.675 and greater than 0.65.

As shown in FIGS. 1H and 1I, in this embodiment, a ratio of a diameter D of the impeller 122 to a value of ¼ of perimeter of the first opening 119 is greater than 0.7. For example, the diameter D of the impeller 122 is 133 mm and the value of ¼ of the perimeter of the first opening 119 is (192.6×2+184.6×2)/4=188.6 mm. Therefore, the ratio of a diameter D of the impeller 122 to a value of ¼ of perimeter of the first opening 119 is 0.705 and greater than 0.7.

As shown in FIG. 1K, in this embodiment, a ratio of an area B1 of the inlet opening 1211 to an area B2 of the first opening 119 is greater than 0.25.

According to the detailed design of the size of the housing 11 and the fan module 12 described above, the performance of the ventilation fan 1 can be improved.

As shown in FIG. 1D, the fan module 12 has a first projection plane A1 on the top plate 118, and the installation opening C1 has a second projection plane A2 on the top plate 118. The size of the first projection plane A1 is smaller than that of the second projection plane A2, and the first projection plane A1 is at least partially overlapped with the second projection plane A2. Accordingly, the fan module 12 can be individually removed through the first opening 119 of the housing 11 and the installation opening C1 of the ceiling C for maintenance procedure.

The detailed design of the lamp module will be described hereinafter.

As shown in FIGS. 1C to 1D, the lamp module 13 is disposed out of the installation opening C1 of the ceiling C, and the lamp module 13 and the housing 11 are located at opposite sides of the ceiling C. In this embodiment, the lamp module 13 is a flat lamp module. In more detailed, the lamp module 13 includes a light source B, a base 131, at least one optical component 132, and a lamp cover 133. The optical component 132 is disposed on the base 131, and the lamp cover 133 is disposed at one side of the optical component 132 away from the base 131. In this embodiment, the light source B comprises at least one light-emitting diode (LED) and disposed at the side of the optical component 132. The LED and the driver thereof can be integrated in one substrate together, i.e. “driver on board (DOB)”, and this disclosure is not limited thereto. In more detailed, the light source B and the at least one optical component 132 are disposed between the base 131 and the lamp cover 133; and the light source B is disposed at the side of the optical component 132.

In this embodiment, the optical component 132 is a light diffuser, which is configured to receive the light emitted from the light source B of the lamp module 13. As shown in FIGS. 1C to 1D, the light emitted from the light source B of the flat lamp module 13 enters the optical component 132. The optical component 132 is a light diffuser which is roughly a rectangular plane. In this embodiment, the light can enter the light diffuser, pass through the lamp cover 133, and then be emitted out departing from the ceiling C and the housing 11 to obtain a uniform-and-plane light. In other words, the light output direction of the light source B of the lamp module 13 is not equal to the light output direction of the lamp module 13. In this case, the light output direction of the light source B of the lamp module 13 is substantially perpendicular to the light output direction of the lamp module 13.

In another embodiment, the lamp module 13 may further comprises a light guide plate G. The light guide plate G is connected to the light source B and the optical component 132. The light guide plate G is configured to receive the light emitted from the light source B of the lamp module 13. As shown in FIGS. 1C and 1D, the light emitted from the light source B of the flat lamp module 13 enters the light guide plate G and then emitted to the optical component 132. The optical component 132 is a light diffuser which is roughly a rectangular plane. In this embodiment, the light can enter the light guide plate G and then enter the light diffuser, pass through the lamp cover 133, and then be emitted out departing from the ceiling C and the housing 11 to obtain a uniform-and-plane light. In other words, the light output direction of the light source B of the lamp module 13 is not equal to the light output direction of the lamp module 13. In this case, the light output direction of the light source B of the lamp module 13 is substantially perpendicular to the light output direction of the lamp module 13.

In this embodiment, the lamp module 13 has a flat design and is configured with the diffuser for obtaining a uniform-and-plane light. Compared with the conventional LED light source, the lamp module 13 of this embodiment can provide the light with uniform, softness and non-dazzling lighting sensitivity. In addition, the lamp module 13 further includes a heat-dissipating element (e.g. a heat sink), which can be disposed on the base 131 or attached to the substrate for dissipating heat. In other embodiments, the lamp module 13 can have a dimmable switch for providing the light dimming function based on various situations. For example, the light dimming function may change the light color, the brightness and the light frequency, so that the ventilation fan of the disclosure can provide multiple illumination modes for various situations. In other embodiments, the lamp module 13 may utilize different optical components for various illumination requirements. For example, the optical component may include a lens or a lens set. The lens is disposed opposite to the base and connected to the lamp cover for providing different illumination effects according to the light concentration and divergence abilities of the lens.

The ventilation fan of this embodiment further includes an elastic element, which will be described hereinafter.

As shown in FIG. 1D, the ventilation fan 1 further includes at least one elastic element E. In one embodiment, the lamp module 13 can be fixed outside of the installation opening C1 of the ceiling C by disposing the elastic element E through the extension portion 114 of the housing 11. In other embodiments, the housing 11 may have multiple extension portions 114. As shown in FIGS. 1F and 1J, in another embodiment, the frame 121 may further comprises at least one extension portion 1216, the at least one extension portion 1216 is disposed on the frame 121, a slot is formed on the at least one extension portion 1216, the lamp module 13 can be fixed outside of the installation opening C1 of the ceiling C by disposing the elastic element E through the extension portion 1216 of the frame 121. This configuration can further firmly fix the lamp module 13 when installing the ventilation fan 1. In more specific, the elastic element E is roughly a metal element with a V-shaped structure, and each of two ends of the elastic element E has a hook structure E1. A ring structure E2 is configured at the bottom of the V-shaped structure and between the two hook structures E1. The ring structure E2 is partially connected to the outer case of the lamp module 13.

As shown in FIG. 1D, when installing the lamp module 13 outside the installation opening C1 of the ceiling C, the two hook structures E1 are pressed to close to each other, so that the elastic element E can pass through the slot of the extension portion 114 of the housing 11. Then, the two hook structures E1 are released and hooked to the extension portion 114. When uninstalling the lamp module 13, the user can press the two hook structures E1 to close to each other, and then remove the hook structures E1 from the extension portion 114.

Alternatively, as shown in FIG. 1J, when installing the lamp module 13 outside the installation opening C1 of the ceiling C, the two hook structures E1 are pressed to close to each other, so that the elastic element E can pass through the slot of the extension portion 1216 of the frame 121. Then, the two hook structures E1 are released and hooked to the extension portion 1216. When uninstalling the lamp module 13, the user can press the two hook structures E1 to close to each other, and then remove the hook structures E1 from the extension portion 1216.

Thus, the lamp module 13 can be easily pulled down and released from the fixing status, and no additional tool is needed. This feature allows to easily install and uninstall the lamp module 13 and is benefit to the repairing and maintenance of the ventilation fan 1. Due to the design of the elastic element E, the lamp module 13 can be suspended during uninstalling the lamp module 13 when the hook structures are still stuck in the extension portion 114 of the housing 11 or the extension portion 1216 of the frame 121. In other words, the elastic element E penetrating through the slot is for preventing the lamp module 13 from falling down directly during disassembling. Besides, the user can press the hook structures E1 of the elastic element E to remove the lamp module 13.

As shown in FIG. 1D, after fixing the lamp module 13 on the installation opening C1 of the ceiling C by the elastic element E, the lamp module 13 can be contacted against the ceiling C. And a gap I is configured between the lamp module 13 and the ceiling C. In this embodiment, the support 15 is disposed between the ceiling C and the lamp module 13. The support 15 contacts the ceiling C, and a gap I is configured between the lamp module 13 and the support 15. In practice, the gap I serves as an air inlet of the ventilation fan 1. In more specific, the gap I is disposed between the lower surface of the support 15 and the upper surface of the outer case of the lamp module 13, and the gap I is called a side-entry air inlet.

In this embodiment, the configuration of the elastic element E can absorb the installation gap between the support 15 and the ceiling C. The lamp module 13 and the support 15 are connected by the contact portion 1312. Herein, the length of the gap I, which serves as the air inlet, is substantially between 5 mm and 20 mm.

The operation of the ventilation fan 1 will be described hereinafter.

To be noted, the airflow can flow from the gap I to the place between the ceiling C and the lamp module 13, and pass through the installation opening C1 of the ceiling C and the first opening 119 of the housing 11, and then enter the housing 11. As shown in FIG. 1D, the inlet opening 1211 of the frame 121 is disposed on the surface of the frame 121 close to the first opening 119 so that the inlet opening 1211 and the first opening 119 are facing toward the same direction. Accordingly, the inlet opening 1211 of the fan module 12 can directly guide the air inputted from the gap I, thereby increasing the air input efficiency. Then, the air flows through the inlet opening 1211 of the frame 121 and flows out through the outlet opening 1212 and the air outlet 112 of the housing 11. In addition, the fan module 12 of this embodiment further includes a baffle plate 124 disposed in the duct T which surrounded the air outlet 112. When the fan module 12 is not in operation, the baffle plate 124 can prevent the reverse flow of the air outside the air outlet 112. Moreover, the lamp module 13 may have an independent switch so that the user can individually turn on/off the lamp module 12 with regard less the operation of the fan module 12. In other words, the air-exchanging function and the illumination function can be separately controlled.

As mentioned above, the ventilation fan 1 of this embodiment is installed to the ceiling C having an installation opening C1. The ventilation fan 1 includes a housing 11, a fan module 122, a power box 17, a junction box 18, and a lamp module 13. The housing 11 has a top plate 118 and a side wall 117. The top plate 118 and the side wall 118 are connected with each other and form a first opening 119. The first opening 119 connects to the installation opening C1. The power box 17 is connected to the fan module 12. And then the power box 17 and the fan module 12 are accommodated in the housing 11 together. Three accommodation spaces Pare formed between the housing 11 and the fan module 12 at different corners of the housing 11. The power box 17 and the junction box 18 are located at different accommodation spaces P (P1, P2, or P3). The lamp module 13 is disposed out of the installation opening C1 of the ceiling C, and the lamp module 13 and the housing 11 are located at opposite sides of the ceiling C. The ventilation fan 1 has a side-entry air inlet design, so that the lamp module 13 can block the noise generated by the fan module 12 in operation. Besides, the internal structure of the ventilation fan 1 cannot be viewed by the user directly so that the appearance of the ventilation fan 1 becomes more elegant. Since the lamp module 13 is integrated in the ventilation fan 1, it can be fit to various environments and reduce the required installation space of the ventilation fan 1 in the ceiling C so as to increase the utility rate of the space. Moreover, the specific design of the size of some elements in the ventilation fan 1 and the design of the power box 17 and the junction box 18 can improve the performance of the ventilation fan 1.

Some aspects of the support 15 of the ventilation fan will be described hereinafter.

The ventilation fans 1 and 1a of FIGS. 1B and 1C are different in the filter 152 disposed in the support 15. In the ventilation fan 1 of FIG. 1B, the filter 152 is a pre-filter. The filter 152 can be optionally installed or removed based on the requirement of the user. As shown in FIG. 1C, the ventilation fan 1a is not configured with the filter 152.

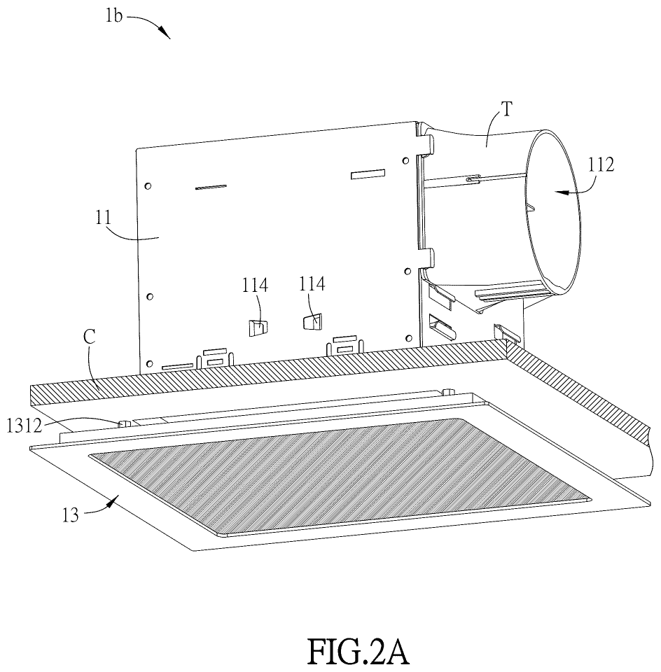

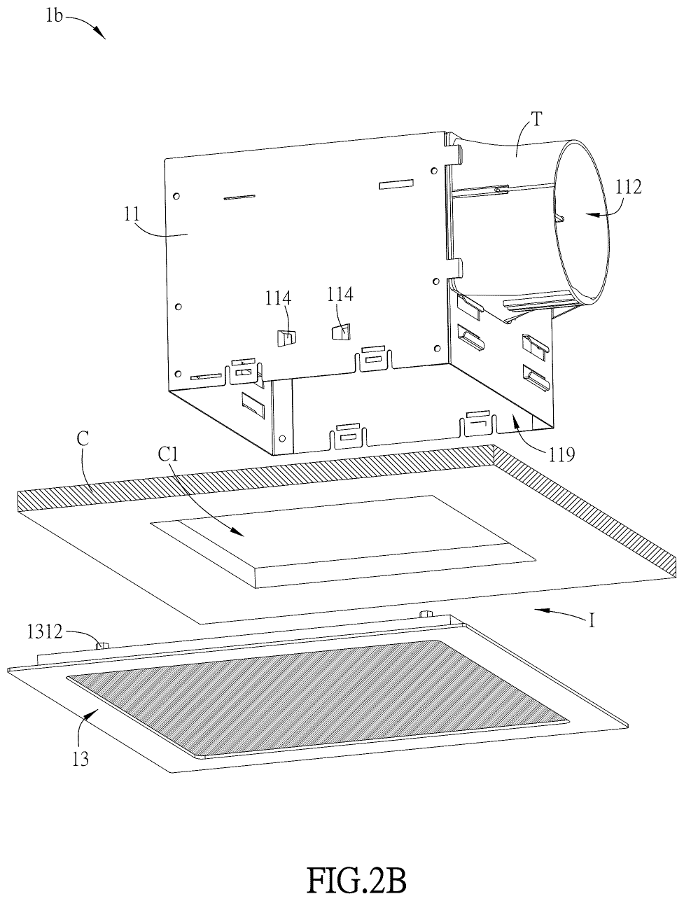

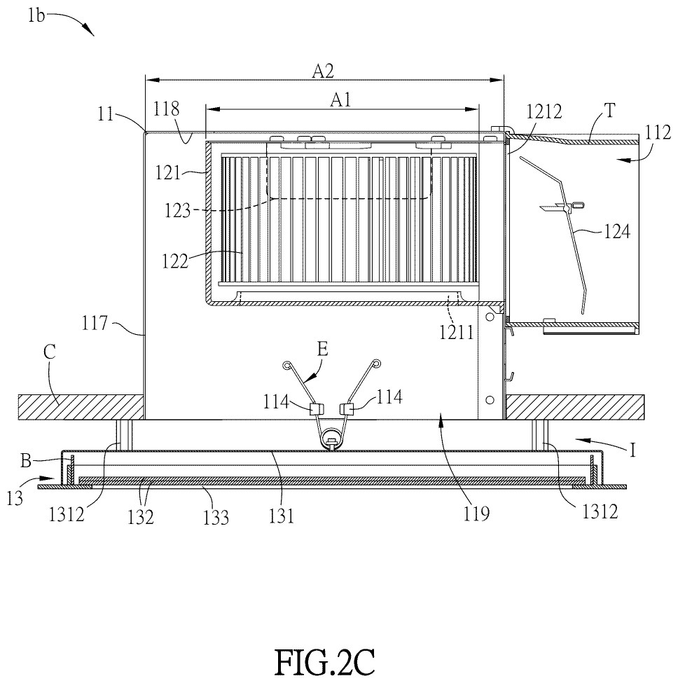

FIG. 2A is a schematic diagram of a ventilation fan with a lamp of the second embodiment of the invention, FIG. 2B is an exploded view of the ventilation fan of FIG. 2A, and FIG. 2C is a sectional diagram of the ventilation fan of FIG. 2A.

As shown in FIGS. 2A to 2C, the ventilation fan 1b may be optionally configured without the support 15 so that the lamp module 13 can be directly contacted against the ceiling C via the contact portion 1312 thereof. A gap I is formed between the lamp module 13 and the ceiling C, and the gap I is substantially the air inlet of the ventilation fan 1b. Moreover, the gap I between the lamp module 13 and the ceiling C can be properly adjusted by the contact portion 1312 for matching the airflow field design of the ventilation fan 1b. That is, the length of the contact portion 1312 is the same as the width of the gap I.

The other technical features of the ventilation fan 1b can be referred to the above-mentioned ventilation fan 1, and the detailed description thereof will be omitted.

In summary, the ventilation fan with the lamp of this disclosure is installed to the ceiling having an installation opening. The ventilation fan includes a housing, a fan module, a power box, a junction box, and a lamp module. The housing has a top plate and a side wall. The top plate and the side wall are connected with each other and form a first opening. The first opening connects to the installation opening. The power box is connected to the fan module. And then the power box and the fan module is accommodated in the housing together. Three accommodation spaces are formed between the housing and the fan module at different corners of the housing. The power box and the junction box are located at different accommodation spaces. The lamp module is disposed out of the installation opening, and the lamp module and the housing are located at opposite sides of the ceiling. The lamp module can further block the noise generated by the fan module in operation. Besides, the internal structure of the ventilation fan cannot be viewed by the user directly, so that the appearance of the ventilation fan becomes more elegant. Since the lamp module is integrated in the ventilation fan, it can be fit to various environments so the flexibility and freedom degree for installing the ventilation fan are enhanced. Moreover, this disclosure can reduce the required installation space of the ceiling so as to increase the utility rate of the space. Since the lamp module and the first opening are disposed at opposite sides of the ceiling, the ventilation fan can have large inlet quantity and good air-exchange efficiency. Moreover, the specific design of the size of some elements in the ventilation fan and the design of the power box and the junction box can improve the performance of the ventilation fan.

Although the present invention is described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A ventilation system comprising a ventilation fan with a lamp for installing to a ceiling having an installation opening, wherein the ventilation fan with the lamp are adapted for installing to the installation opening of the ceiling, the ventilation fan comprises:
a housing comprising a top plate and a side wall, wherein the top plate and the side wall are connected with each other to form a first opening, the first opening is aligned with the installation opening, and an air outlet is formed at the side wall;
a fan module disposed in the housing, the fan module comprises a frame, an impeller disposed in the frame and a motor connected to and driving the impeller to rotate, the frame comprises a pillow disposed at the bottom of the frame, the frame and the pillow are connected with each other to form an inlet opening and an outlet opening, the inlet opening is aligned with the first opening, the outlet opening communicates with the air outlet of the housing, three accommodation spaces are formed between the housing and the fan module at different corners of the housing and disposed away from the air outlet of the housing, respectively;
a power box disposed in the housing and located at one of the accommodation space, the power box comprises a first circuit board, the first circuit board is disposed in the power box;
a junction box disposed in the housing and located at one of the accommodation space, wherein the power box and the junction box are located at different accommodation spaces;
a lamp module disposed out of the installation opening and covering the installation opening, wherein the lamp module and the housing are located at opposite sides of the installation opening of the ceiling, a gap is formed between the lamp module and the ceiling, and the gap serves as an air inlet of the ventilation fan; and
a support disposed between the ceiling and the lamp module;
wherein the junction box is electrically connected to the first circuit board of the power box and the lamp module;
wherein the impeller comprises a hub, and a ratio of a height of the hub to a height of the housing is less than 0.5; and
wherein a ratio of a height of the impeller to a height of the housing is greater than 0.65.

2. The ventilation system as recited in claim 1, wherein the fan module further comprises:
a second circuit board disposed in the frame and electrically connected to the motor and the first circuit board of the power box.

3. The ventilation system as recited in claim 2, wherein the motor is an external-rotor DC motor.

4. The ventilation system as recited in claim 2, wherein the frame further comprises a shaft tube disposed at the pillow, and the second circuit board is disposed around the outer periphery of the shaft tube.

5. The ventilation system as recited in claim 4, wherein the second circuit board is a circular board and comprising a water-proof structure.

6. The ventilation system as recited in claim 1, wherein the housing further comprises at least one installation hole, the junction box is disposed in the housing by installing to the at least one installation hole.

7. The ventilation system as recited in claim 2, wherein the frame further comprises a mounting portion, the power box is connected to the mounting portion and then disposed in the housing with the fan module.

8. The ventilation system as recited in claim 1, wherein the housing further comprises at least one extension portion, the at least one extension portion is disposed on the side wall inside the housing, a slot is formed on the at least one extension portion, the lamp module comprises at least one elastic element, and the at least one elastic element penetrating through the slot for preventing the lamp module from falling down directly during disassembling.

9. The ventilation system as recited in claim 2, wherein the frame further comprises at least one extension portion, the at least one extension portion is disposed on the frame, a slot is formed on the at least one extension portion, the lamp module comprises at least one elastic element, and the at least one elastic element penetrating through the slot for preventing the lamp module from falling down directly during disassembling.

10. The ventilation system as recited in claim 1, wherein a height of the housing is equal to or less than 4 inch.

11. The ventilation system as recited in claim 1, wherein a ratio of a diameter of the impeller to a value of ¼ of perimeter of the first opening is greater than 0.7.

12. The ventilation system as recited in claim 1, wherein a ratio of an area of the inlet opening to an area of the first opening is greater than 0.25.

13. The ventilation system as recited in claim 1, wherein the first circuit board of the power box outputs DC power to the fan module.

14. The ventilation system as recited in claim 1, wherein the support contacts the ceiling.

15. The ventilation system as recited in claim 14, wherein the lamp module and the support are connected by a contact portion, and the gap is configured between the lamp module and the support.

16. The ventilation system as recited in claim 1, wherein the lamp module comprises a light source, a base, at least one optical component, and a lamp cover, the optical component is disposed on the base, the lamp cover is disposed at one side of the optical component away from the base, and the light output direction of the light source of the lamp module is not equal to the light output direction of the lamp module.

17. The ventilation system as recited in claim 16, wherein the optical component is a light diffuser, and the light diffuser receives the light emitted from the light source of the lamp module.

18. The ventilation system as recited in claim 17, wherein the light source is disposed at the side of the light diffuser.
